(19) United States
(12) Patent Application Publication
(10) Pub. No.: US 2023/0150785 A1
(43) Pub. Date: May 18, 2023

(54) APPARATUS FOR APPLYING A STRIP COMPRISING A MICROCREPED PAPER

(71) Applicant: tesa SE, Norderstedt (DE)

(72) Inventors: Michael SCHWERTFEGER, Hamburg (DE); Niklas HANSEN, Hamburg (DE); Daniela NEDDERMEIER, Hamburg (DE)

(73) Assignee: tesa SE, Norderstedt (DE)

(21) Appl. No.: 17/969,351

(22) Filed: Oct. 19, 2022

(30) Foreign Application Priority Data
Nov. 17, 2021 (DE) 10 2021 130 079.7

(51) Int. Cl. B65H 23/16; B65H 23/182

(52) U.S. Cl. CPC B65H 23/16; B65H 23/182; B65H 2401/10; B65H 2408/24; B65H 2701/11332; B65H 2701/1722

(57) ABSTRACT

Apparatus for applying a strip P comprising at least one microcreped paper to a carrier material T, where the apparatus comprises the strip P, wound to a reel S, and rotatably mounted rollers R₁, R₂ and R₃ for guiding the strip P at least partly unwound from the reel, where the at least one microcreped paper comprised in the strip P wound to the reel has a tensile strength of at least 8 kN/m, an extensibility of at least 4% and a tearing resistance of at least 1200 mN.

The present invention relates to an apparatus for applying a strip comprising at least one microcreped paper to a carrier material. The present invention further relates to a method for applying a strip comprising at least one microcreped paper to a carrier material. Additionally the present invention relates to a use of said apparatus and also to a carrier material comprising a strip, obtained or obtainable by said method. Apparatuses and methods of the type stated may be used, for example, in the field of packaging technology, preferably in the production of packaging. Hence the invention may be employed more particularly in the production of packaging, for example for producing tear strips on a corrugated board line, on a folding box line and/or on a plain bonding line. Other fields of use are also conceivable in principle, however.

Within the packaging industry, sustainable packaging which as far as possible is environmentally neutral and can be used again in terms of its material is increasingly gaining in importance. On account of the generally easy recycling and also of a generally smaller CO₂ footprint, paper has a particular part to play in boosting sustainability in the packaging industry. For the reprocessing of paper, however, it is generally very important that no substances that hinder processing enter into what is referred to as the pulp. Prior to reuse, therefore, plastics materials in particular, such as films, for example, must therefore be removed, and this is costly and complicated. In the production of packaging, therefore, it is generally useful to aim at reducing plastics materials or even omitting them entirely.

However, plastics materials, such as film strips, for example, are generally used, usually in the form of a self-adhesive tape, for the production of tear strips for opening packaging, in particular. The self-adhesive tear strips are applied automatically by corresponding unwind apparatuses during the production of the packaging itself. For example, DE 299 17 738 U1 describes an apparatus for unwinding a roll of a narrow material furnished self-adhesively on at least one side. These apparatuses and methods are generally suitable for plastics films and/or plastics adhesive tapes which are not sensitive in their handling. For the handling of paper, which in general operation is markedly more sensitive, however, known apparatuses and methods are commonly not suitable.

It is therefore desirable to provide apparatuses and methods which avoid or very largely avoid the described disadvantages of aforementioned apparatuses and methods. The apparatuses and methods are intended more particularly to enable the production of sustainable packaging.

This object is addressed by an apparatus for applying a strip comprising at least one microcreped paper to a carrier material, by a method for applying a strip comprising at least one microcreped paper to a carrier material, by a use of said apparatus and by a carrier material comprising a strip and obtained or obtainable by said method, having the features of the independent claims. Advantageous developments, which may be realized individually or in combination, are set out in the description and the dependent claims.

The present invention therefore relates to an apparatus for applying a strip P comprising at least one microcreped paper to a carrier material T, where the strip P has an areal extent with a length l, a width b and a thickness d where l>>b>d, and where the apparatus comprises:
(I) the strip P comprising a microcreped paper and wound to a reel S, where the reel S is mounted rotatably about a reel axis A_{S};
(II) rotatably mounted rollers R₁, R₂ and R₃ for guiding the strip P at least partly unwound from the reel, where the roller R₁ is downstream of the reel S, the roller R₂ is downstream of the roller R₁, and the roller R₃ is downstream of the roller R₂; where
   (II.1) the roller R₁ has a rotational axis A₁, where the angle α₁ between the rotational axis A₁ and the reel axis A_{S} is 0°, with a tolerance of ±5°;
   (II.2) the roller R₂ has a rotational axis A₂, where the angle α₂ between the rotational axis A₂ and the reel axis A_{S} is 0°, with a tolerance of ±10°;
   (II.3) the roller R₃ has a rotational axis A₃, where the angle α₃ between the rotational axis A₃ and the rotational axis A₂ is 90°, with a tolerance of ±1°;
(III) at least one application apparatus V, downstream of the roller R₃, for applying the strip P to the carrier material T;
   where the at least one microcreped paper comprised in the strip P wound to the reel has the following properties:
(a) a tensile strength F_{Z} in at least one direction within the areal extent of the strip P, where F_{Z}≥8 kN/m (kilonewtons/metre), determined according to ISO 1924-3: 2005 “Paper and board—Determination of tensile properties—Part 3”;
(b) an extensibility F_{D} in at least one direction within the areal extent of the strip P, where F_{D}≥4%, determined according to ISO 1924-3: 2005 “Paper and board—Determination of tensile properties—Part 3”;
(c) a tearing resistance F_{R} in at least one direction within the areal extent of the strip P, where F_{R}≥1200 mN (millinewtons), determined according to ISO 1974: 2012 “Paper—Determination of tearing resistance—Elmendorf method”.

The at least one microcreped paper contained in the strip P preferably has a tensile strength F_{Z} of 8 kN/m≤F_{Z}≤22 kN/m more preferably of 10 kN/m≤F_{Z}≤21 kN/m, more preferably of 13 kN/m≤F_{Z}≤20 kN/m such as, for example, of 15 kN/m≤F_{Z}≤20 kN/m or of 17 kN/m≤F_{Z}≤20 kN/m or of 19 kN/m≤F_{Z}≤20 kN/m.

The at least one microcreped paper contained in the strip P preferably has an extensibility F_{D} of 4%≤F_{D}≤16%, more preferably of 6%≤F_{D}≤15.5%, more preferably of 8%≤F_{D}≤15% such as, for example, of 10%≤F_{D}≤15% or of 12%≤F_{D}≤15% or of 14%≤F_{D}≤15%.

The at least one microcreped paper contained in the strip P preferably has a tearing resistance F_{R} of 1200 mN≤F_{R}≤4500 mN, more preferably of 1500 mN≤F_{R}≤4000 mN, more preferably of 2000 mN≤F_{R}≤3500 mN such as, for example, of 2500 mN≤F_{R}≤3500 mN or of 3000 mN≤F_{R}≤3500 mN.

The microcreped paper contained in the strip P preferably has a grammage G of at least 80 g/m², more preferably of 80 g/m²≤G≤180 g/m², more preferably of 120 g/m²≤G≤160 g/m² such as, for example, of 120 g/m²≤G≤140 g/m² or of 130 g/m²≤G≤150 g/m² or of 140 g/m²≤G≤160 g/m².

The at least one microcreped paper contained in the strip P is microcreped fundamentally in at least one, preferably in at least two, direction(s) within the areal extent.

Accordingly the present invention further preferably relates to the abovementioned apparatus where the at least one microcreped paper comprised in the strip P wound to the reel has the following properties:
(a) a tensile strength F_{Z} in at least one direction within the areal extent of the strip P, where 13 kN/m≤F_{Z}≤20 kN/m, determined according to ISO 1924-3: 2005 “Paper and board—Determination of tensile properties—Part 3”;
(b) an extensibility F_{D} in at least one direction within the areal extent of the strip P, where 8%≤F_{D}≤15%, determined according to ISO 1924-3: 2005 “Paper and board—Determination of tensile properties—Part 3”;
(c) a tearing resistance F_{R} in at least one direction within the areal extent of the strip P, where 2000 mN≤F_{R}≤3500 mN, determined according to ISO 1974: 2012 “Paper—Determination of tearing resistance—Elmendorf method”;

where the at least one microcreped paper contained in the strip P is microcreped preferably in at least two directions within the areal extent.

In terms of the width b there are in principle no particular restrictions. The strip P preferably has a width b of 2 mm≤b≤25 mm, more preferably 3 mm≤b≤15 mm, more preferably of 4 mm≤b≤8 mm such as, for example, of 4 mm≤b≤6 mm or of 5 mm≤b≤7 mm or of 6 mm≤b≤8 mm.

In terms of the thickness d there are in principle no particular restrictions. The strip P preferably has a thickness d of 100 μm≤d≤400 μm, more preferably of 150 μm≤d≤350 μm, more preferably of 200 μm≤d≤300 μm such as, for example, of 200 μm≤d≤250 μm or of 225 μm≤d≤275 μm or of 250 μm≤d≤300 μm.

Preferably from 95 to 100% by weight of the strip P consists of the at least one microcreped paper. More preferably from 98 to 100%, more preferably from 99 to 100%, more preferably from 99.5 to 100%, more preferably from 99.9 to 100% by weight of the strip P consists of the at least one microcreped paper.

With further preference the strip P comprises a single microcreped paper, where more preferably from 95 to 100%, more preferably from 98 to 100%, more preferably from 99 to 100%, more preferably from 99.5 to 100%, more preferably from 99.9 to 100% by weight of the strip P consists of the single microcreped paper.

Accordingly the present invention with further preference relates to the abovementioned apparatus where the at least one microcreped paper comprised in the strip P wound to the reel has the following properties:
(a) a tensile strength F_{Z} in at least one direction within the areal extent of the strip P, where 13 kN/m≤F_{Z}≤20 kN/m, determined according to ISO 1924-3: 2005 “Paper and board—Determination of tensile properties—Part 3”;
(b) an extensibility F_{D} in at least one direction within the areal extent of the strip P, where 8%≤F_{D}≤15%, determined according to ISO 1924-3: 2005 “Paper and board—Determination of tensile properties—Part 3”;
(c) a tearing resistance F_{R} in at least one direction within the areal extent of the strip P, where 2000 mN≤F_{R}≤3500 mN, determined according to ISO 1974: 2012 “Paper—Determination of tearing resistance—Elmendorf method”;

where the at least one microcreped paper contained in the strip P is microcreped preferably in at least two directions within the areal extent and where from 99.9 to 100% by weight of the strip P consists of the at least one microcreped paper, preferably of a single microcreped paper.

In principle it is possible that the strip P has at least the following layers:
(i) a first layer, comprising the at least one paper defined in one of the versions above;
(ii) a bonding layer disposed on a first side of the paper layer;
(iii) an adhesion-reducing layer arranged on a second side of the paper layer, opposite the first side, where that surface of the adhesion-reducing layer that faces away from the paper layer is configured such that a surface of the bonding layer that faces away from the paper side and is brought into contact with said surface of the adhesion-reducing layer is detachable substantially without destruction.

Additionally, optionally, from 0 to 5% by weight of the bonding layer of (ii) consists of one or more organic solvents. Preferably from 0 to 3% by weight of the bonding layer of (ii) consists of one or more organic solvents. More preferably from 0 to 1% by weight of the bonding layer of (ii) consists of one or more organic solvents. With further preference from 0 to 0.5% by weight of the bonding layer of (ii) consists of one or more organic solvents. With further preference from 0 to 0.1% by weight of the bonding layer of (ii) consists of one or more organic solvents.

The reel S is preferably a cross-wound reel, more preferably a criss-cross-wound reel. The strip P wound to the reel has, for example, a helical winding, where the strip P preferably forms at least two layers and the direction switches from layer to layer between right-handed and left-handed. The separation point T at which the strip P parts from the reel S on unwinding preferably performs a back-and-forth movement parallel to the reel axis A_{S} when the strip P is unwound.

In its non-unwound state, the reel S preferably has a diameter D of at most 500 mm, more preferably of 100 mm≤D≤500 mm, more preferably of 200 mm≤D≤450 mm, more preferably of 300 mm≤D≤400 mm.

The reel S preferably has an extent L in the direction of the reel axis A_{S} of at most 350 mm, more preferably of 100 mm≤L≤350 mm, more preferably of 160 mm≤L≤200 mm. The reel S for example has an extent L in the direction of the reel axis A_{S} of L=180 mm.

The rollers R₁, R₂ and R₃ are preferably cylindrical rollers, and at least one of the rollers R₁, R₂ and R₃ has a substantially flange-free configuration on at least one side. The rollers R₁, R₂ and R₃ are preferably cylindrical rollers, and at least one of the rollers R₁, R₂ and R₃ has a substantially flange-free configuration on both sides. More preferably the rollers R₁, R₂ and R₃ are cylindrical rollers, and all the rollers R₁, R₂ and R₃ have a substantially flange-free configuration on at least one side. With further preference the rollers R₁, R₂ and R₃ are cylindrical rollers and all the rollers R₁, R₂ and R₃ have a substantially flange-free configuration on both sides. A flange-free configuration of the rollers in this way is advantageous, for example, in order to prevent damage to the edges of the strip P when it is being guided over the respective roller.

Preferably at least one of the rollers R₁, R₂ and R₃ is a drive-free roller. More preferably all the rollers R₁, R₂ and R₃ are drive-free rollers.

The roller R₁ preferably has an outer diameter in the range from 5 to 100 mm, more preferably in the range from 7 to 40 mm, more preferably in the range from 10 to 30 mm.

The roller R₂ preferably has an outer diameter in the range from 5 to 100 mm, more preferably in the range from 15 to 50 mm, more preferably in the range from 25 to 30 mm.

The roller R₃ preferably has an outer diameter in the range from 5 to 100 mm, more preferably in the range from 15 to 50 mm, more preferably in the range from 25 to 30 mm.

With further preference, therefore, the roller R₁ has an outer diameter in the range from 10 to 30 mm, the roller R₂ an outer diameter in the range from 25 to 30 mm, and the roller R₃ an outer diameter in the range from 25 to 30 mm.

Preferably at least one of the rollers R₁, R₂ and R₃ has an extent along its respective rotational axis of at least 100 mm. More preferably at least two of the rollers R₁, R₂ and R₃ have an extent along their respective rotational axis of at least 100 mm. More preferably all the rollers R₁, R₂ and R₃ have an extent along their respective rotational axis of at least 100 mm.

The extent of at least one of the rollers R₁, R₂ and R₃, preferably of all the rollers R₁, R₂ and R₃, along their respective rotational axis, independently of one another, is preferably at least L+10 mm, where L is the extent of the reel S in the direction of the reel axis A_{S}. With further preference the extent of at least one of the rollers R₁, R₂ and R₃, more preferably of least two of the rollers R₁, R₂ and R₃, more preferably of all the rollers R₁, R₂ and R₃ along their respective rotational axis is in the range from (L+10 mm) to (L+20 mm), more preferably in the range from (L+10 mm) to (L+15 mm).

The roller R₃ is preferably arranged in such a way that in the guiding of the strip P, the first contact point between the strip P and the roller R₃ lies in the plane of an end face of the reel S or is arranged at a distance from this plane in a direction away from the reel. An arrangement of the roller R₃ of this kind is especially suitable for converting a back-and-forth movement of the strip P on unwinding from the reel S, as described above, into a linear, preferably a stable linear, movement. Hence by this means a zig-zag movement of the strip P on unwinding can be converted into a smooth movement.

The rotational axis A₁ of the roller R₁ is preferably positioned movably in space in such a way that the roller R₁ contacts the reel S during the unwinding of the strip P. With further preference the rotational axis A₁ of the roller R₁ is positioned movably in space in such a way that the roller R₁ contacts the reel S linearly during the unwinding of the strip P. With preference additionally the rotational axis A₁ of the roller R₁ is positioned movably in space in such a way that the rotational axis A₁ during the unwinding of the strip P performs a movement in a radial direction relative to the reel axis A_{S}.

The rollers R₂ and R₃ are preferably guide rollers disposed as spatially fixed rotational axes.

The reel axis A_{S} is preferably arranged as a spatially fixed rotational axis.

The rotational axes A₁ and A₂ are preferably disposed in such a way that the free length of the strip P between the roller R₁ and the roller R₂ is in the range from 150 to 500 mm, more preferably in the range from 200 to 300 mm. The term “free length” as used here denotes the length of the strip P between the last contact point of the strip P with the roller R₁ and the first contact point of the strip P with the roller R₂ when the strip P is guided over these rollers.

The rotational axes A₂ and A₃ are preferably disposed in such a way that the free length of the strip P between the roller R₂ and the roller R₃ is in the range from 150 to 500 mm, more preferably in the range from 200 to 300 mm. The term “free length” as used here denotes the length of the strip P between the last contact point of the strip P with the roller R₂ and the first contact point of the strip P with the roller R₃ when the strip P is guided over these rollers.

According to one possible embodiment of the present invention, the roller R₃ is the last roller for guiding the strip P before the strip P is applied to the carrier material T.

According to a further possible embodiment of the present invention, the apparatus, additionally to the three rollers R₁, R₂ and R₃, comprises a further rotatably mounted roller R₄ for guiding the strip P unwound at least partly from the reel, the roller R₄ being downstream of the roller R₃, where
(II.4) the roller R₄ has a rotational axis A₄, where the angle α₄ between the rotational axis A₄ and the rotational axis A₃ is 90°, with a tolerance of ±1°.

The roller R₄ preferably has a guide flange on at least one side, preferably on both sides. With further preference the roller R₄ has a guide flange on both sides. With additional preference the guide flanges disposed on both sides have a distance from one another in the range from (b+0.1 mm) to (b+0.9 mm), more preferably in the range from (b+0.2 mm) to (b+0.8 mm), more preferably in the range from (b+0.3 mm) to (b+0.7 mm).

The roller R₄, if present, is preferably the last roller for guiding the strip P before the strip P is applied to the carrier material T.

According to a further possible embodiment of the present invention, the apparatus, additionally, comprises a rotatably mounted roller R₅ for guiding the strip P unwound at least partly from the reel, the roller R₅ being downstream of the roller R₄, where
(II.5) the roller R₅ has a rotational axis A_{S}, where the angle as between the rotational axis A_{S} and the rotational axis A₄ is 90°, with a tolerance of ±1°.

The roller R₅ preferably has a guide flange on at least one side, preferably on both sides. With further preference the roller R₅ has a guide flange on both sides. With additional preference the guide flanges disposed on both sides have a distance from one another in the range from (b+0.1 mm) to (b+0.9 mm), more preferably in the range from (b+0.2 mm) to (b+0.8 mm), more preferably in the range from (b+0.3 mm) to (b+0.7 mm).

The roller R₅, if present, is preferably the last roller for guiding the strip P before the strip P is applied to the carrier material T.

In accordance with the present invention the number of rollers additional to the rollers R₁, R₂ and R₃ is dependent on factors including the distance of the roller R₃ from the carrier material T. Hence it may be preferable, for example, to provide at least one roller additional to the rollers R₁, R₂ and R₃ in the case of a distance of R₃ from T of at least 300 mm.

In accordance with the present invention the number of rollers additional to the rollers R₁, R₂ and R₃ is dependent on factors including the movement of the strip P on the roller R₃. Hence it may be preferable, for example, in the case of a deviation in the movement of the strip P on the roller R₃ from a linear movement, for example in the case of a deviation of this kind by at least 2%, to provide an additional roller R₄ or, preferably, a roller pair R₄ and R₅, preferably having a spatial disposition which is analogous to the spatial disposition of the rollers R₂ and R₃.

With regard to the application apparatus V, it is preferably set up in such a way that it exerts at least one force on the strip P in a direction towards the carrier material T. With further preference the application apparatus V is set up in such a way that the force is exerted via at least one rubber roll. Alternatively or additionally the application apparatus V is preferably set up in such a way that the force is exerted via compressed air.

The apparatus preferably comprises additionally at least one bond application apparatus K for applying at least one bonding layer, preferably a bonding layer which comprises at least one hotmelt adhesive, more preferably a bonding layer which consists of at least one hotmelt adhesive. While it is possible in principle to apply the bonding layer to the strip P before the latter is applied to the carrier material T, it is preferred in the context of the present invention for the bonding layer to be applied to the carrier material T before the strip P is applied to the carrier material T bearing the bonding layer. The bonding layer applied to the carrier material preferably has a width of at most the width b of the strip P.

The apparatus preferably additionally comprises at least one separating unit for separating off lengths of the strip P, with the at least one separating unit being preferably downstream of the last roller, such as of the roller R₃ or the roller R₄ or the roller R₅, for example.

The apparatus preferably additionally comprises at least one drive unit for driving the strip P and at least one brake unit for braking the strip P. The drive unit and the brake unit are preferably set up to control a rotational movement of the reel S. The rotational movement of the reel S preferably features an unwind velocity v of the strip P from the reel S of 0 m/min<v≤250 m/min, more preferably of 100 m/min≤v≤200 m/min. For example, the drive unit and the brake unit are set up to control the rotational movement of the reel S as a function of a status of the application apparatus V and/or of the separating unit, preferably in order to adapt the rotational movement to an application procedure and/or to a separating procedure. The drive unit and the brake unit are preferably downstream of the last roller, such as the roller R₃ or the roller R₄ or the roller R₅, for example. Alternatively the drive unit is preferably disposed in such a way as to drive the strip P by accelerating a rotational movement of the roller R₂ or the roller R₃ and the brake unit is disposed in such a way as to brake the strip P by reducing a rotational movement of the reel S. The drive unit is disposed, for example, in the roller R₂ or the roller R₃, with the brake unit being disposed for example in the reel S.

While in principle there are no particular restrictions with regard to the carrier material T, it is preferred in accordance with the present invention that the carrier material T is at least one packaging blank. The packaging blank is preferably a packaging blank made of paper and/or of board, with the packaging blank preferably being a case, a carton, a folding box or a wrapper.

The present invention further relates to a method for applying a strip P comprising at least one microcreped paper to a carrier material T. The method comprises the steps identified in more detail below. These steps may be carried out in the stated order. A different order, however, is also possible in principle. Moreover, two or more of the stated method steps may be carried out simultaneously or with temporal overlap. Furthermore, one or more of the stated method steps may be carried out once or else repeatedly. The method may comprise further method steps beyond the steps stated.

The method comprises the following steps:
a) providing an apparatus as described above or in accordance with one of the embodiments described hereinafter;
b) providing the at least one carrier material T;
c) guiding the strip P from the reel S to the application apparatus V via the at least three rollers R₁, R₂ and R₃;
d) applying the strip P on the carrier material T by means of the application apparatus V.

The step a) preferably comprises a threading of the strip at least between the rollers R₁, R₂ and R₃.

Step c) comprises, for example, a driving of the reel S and of the rollers R₁, R₂ and R₃ via a take-off of the strip P through a movement of the carrier material T. Alternatively or additionally, step c) comprises, for example, a controlling of a movement of the strip P by means of a drive unit and a brake unit, as present optionally above in the apparatus.

The method in step c) preferably comprises a controlling of a rotational movement of the reel S, so that the strip P is unwound from the reel S with an unwind velocity v of 0 m/min<v≤250 m/min, preferably of 100 m/min≤v≤200 m/min.

The applying in step d) preferably comprises an exerting of at least one force on the strip P in a direction towards the carrier material T.

The method preferably further comprises a step e) preceding step d), where
e) providing a bond application apparatus K as present optionally above in the apparatus and applying the bonding layer to the carrier material T by means of the bond application apparatus K.

The strip P is preferably applied in step d) to the bonding layer applied to the carrier material, and so the bonding layer joins the carrier material T and the strip P.

The present invention further relates to an apparatus or a method as described herein where the strip P is a tear strip.

The present invention further relates to the use of an apparatus as described herein for applying a strip P to a carrier material T.

The present invention further relates to a carrier material T comprising a strip P, obtained or obtainable by a method as described herein.

The present invention as described above is additionally described by the following set of embodiments and combinations of embodiments, with the combinations arising from the corresponding dependencies and dependency references. It may be pointed out in particular that at those points where a range of embodiments is mentioned—such as, for example, in connection with an expression such as “apparatus according to any of embodiments 1 to 5”—each individual embodiment within this range is understood as being explicitly disclosed for the skilled person, with the skilled person thus understanding this expression as being synonymous with the expression “apparatus according to any of embodiments 1, 2, 3, 4 and 5”. Further, it may be pointed out explicitly that the following set of embodiments represents not the set of claims determining the scope of protection, but rather a suitably structured part of the description which is directed to general and preferred aspects of the present invention.
1. Apparatus for applying a strip P comprising at least one microcreped paper to a carrier material T, where the strip P has an areal extent with a length l, a width b and a thickness d where l>>b>d, where the apparatus comprises:
   (I) the strip P comprising a microcreped paper and wound to a reel S, where the reel S is mounted rotatably about a reel axis A_{S};
   (II) rotatably mounted rollers R₁, R₂ and R₃ for guiding the strip P at least partly unwound from the reel, where the roller R₁ is downstream of the reel S, the roller R₂ is downstream of the roller R₁, and the roller R₃ is downstream of the roller R₂; where
      (II.1) the roller R₁ has a rotational axis A₁, where the angle α₁ between the rotational axis A₁ and the reel axis A_{S} is 0°, with a tolerance of ±5°;
   (II.2) the roller R₂ has a rotational axis A₂, where the angle α₂ between the rotational axis A₂ and the reel axis A_{S} is 0% with a tolerance of ±10°;
   (II.3) the roller R₃ has a rotational axis A₃, where the angle α₃ between the rotational axis A₃ and the rotational axis A₂ is 90°, with a tolerance of ±1°;
(III) at least one application apparatus V, downstream of the roller R₃, for applying the strip P to the carrier material T;

where the at least one microcreped paper comprised in the strip P wound to the reel has the following properties:
(a) a tensile strength F_{Z} in at least one direction within the areal extent of the strip P, where F_{Z}≥8 kN/m, determined according to ISO 1924-3;
(b) an extensibility F_{D} in at least one direction within the areal extent of the strip P, where F_{D}≥4%, determined according to ISO 1924-3;
(c) a tearing resistance F_{R} in at least one direction within the areal extent of the strip P, where F_{R}≥1200 mN, determined according to ISO 1974.
2. Apparatus according to embodiment 1, where 8 kN/m≤F_{Z}≤22 kN/m, preferably 10 kN/m≤F_{Z}≤21 kN/m, more preferably 13 kN/m≤F_{Z}≤20 kN/m.
3. Apparatus according to embodiment 1 or 2, where 4%≤F_{D}≤16%, preferably 8%≤F_{D}≤15%.
4. Apparatus according to any of embodiments 1 to 3, where 1200 mN≤F_{R}≤4500 mN, preferably 1500 mN≤F_{R}≤4000 mN, more preferably 2000 mN≤F_{R}≤3500 mN.
5. Apparatus according to any of embodiments 1 to 4, where the at least one paper contained in the strip P has a grammage G of at least 80 g/m², preferably 80 g/m²≤G≤180 g/m², more preferably 120 g/m²≤G≤160 g/m².
6. Apparatus according to any of embodiments 1 to 5, where the at least one microcreped paper contained in the strip P is microcreped in at least two directions within the areal extent.
7. Apparatus according to any of embodiments 1 to 6, where 2 mm≤b≤25 mm, preferably 3 mm≤b≤15 mm, more preferably 4 mm≤b≤8 mm.
8. Apparatus according to any of embodiments 1 to 7, where 100 μm≤d≤400 μm, preferably 150 μm≤d≤350 μm, more preferably 200 μm≤d≤300 μm.
9. Apparatus according to any of embodiments 1 to 8, where from 95 to 100%, preferably from 98 to 100%, more preferably from 99 to 100%, more preferably from 99.5 to 100%, more preferably from 99.9 to 100% by weight of the strip P consists of the at least one microcreped paper.
10. Apparatus according to any of embodiments 1 to 9, where the strip P comprises a single microcreped paper and preferably from 95 to 100%, more preferably from 98 to 100%, more preferably from 99 to 100%, more preferably from 99.5 to 100%, more preferably from 99.9 to 100% by weight of the strip P consists of the single microcreped paper.
11. Apparatus according to any of embodiments 1 to 8, where the strip P has at least the following layers:
   (i) a first layer, comprising the at least one paper defined in embodiments 1 to 8;
   (ii) a bonding layer disposed on a first side of the paper layer;
   (iii) an adhesion-reducing layer arranged on a second side of the paper layer, opposite the first side, where that surface of the adhesion-reducing layer that faces away from the paper layer is configured such that a surface of the bonding layer that faces away from the paper side and is brought into contact with said surface of the adhesion-reducing layer is detachable substantially without destruction.
12. Apparatus according to embodiment 11, where from 0 to 5%, preferably from 0 to 3%, more preferably from 0 to 1%, more preferably from 0 to 0.5%, more preferably from 0 to 0.1% by weight of the bonding layer of (ii) consists of one or more organic solvents.
13. Apparatus according to any of embodiments 1 to 12, where the reel S is a cross-wound reel, preferably a criss-cross-wound reel.
14. Apparatus according to embodiment 13, where the separating point T at which the strip P parts from the reel S on unwinding performs a back-and-forth movement parallel to the reel axis A_{S} during unwinding of the strip P.
15. Apparatus according to any of embodiments 1 to 14, where the reel S in its non-unwound state has a diameter D of at most 500 mm, where preferably 100 mm≤D≤500 mm, more preferably 200 mm≤D≤450 mm, more preferably 300 mm≤D≤400 mm.
16. Apparatus according to any of embodiments 1 to 15, where the reel S has an extent L in a direction of the reel axis A_{S} of at most 350 mm, where preferably 100 mm≤L≤350 mm, more preferably 160 mm≤L≤200 mm.
17. Apparatus according to any of embodiments 1 to 16, where the rollers R₁, R₂ and R₃ are cylindrical rollers, where preferably at least one of the rollers R₁, R₂ and R₃, more preferably all the rollers R₁, R₂ and R₃, have a substantially flange-free configuration on at least one side, preferably on both sides.
18. Apparatus according to any of embodiments 1 to 17, where at least one of the rollers R₁, R₂ and R₃, preferably all the rollers R₁, R₂ and R₃, are drive-free rollers.
19. Apparatus according to any of embodiments 1 to 18, where the roller R₁ has an outer diameter in the range from 5 to 100 mm, preferably in the range from 7 to 40 mm, more preferably in the range from 10 to 30 mm.
20. Apparatus according to any of embodiments 1 to 19, preferably according to embodiment 19, where the roller R₂ has an outer diameter in the range from 5 to 100 mm, preferably in the range from 15 to 50 mm, more preferably in the range from 25 to 30 mm.
21. Apparatus according to any of embodiments 1 to 20, preferably according to embodiment 20, more preferably according to embodiment 19 and 20, where the roller R₃ has an outer diameter in the range from 5 to 100 mm, preferably in the range from 15 to 50 mm, more preferably in the range from 25 to 30 mm.
22. Apparatus according to any of embodiments 1 to 21, where at least one of the rollers R₁, R₂ and R₃, preferably all the rollers R₁, R₂ and R₃, have an extent along their respective rotational axis of at least 100 mm.
23. Apparatus according to embodiment 22 in so far as embodiment 22 is dependent on embodiment 16, where the extent of at least one of the rollers R₁, R₂ and R₃, preferably of all the rollers R₁, R₂ and R₃, along their respective rotational axis independently of one another is at least L+10 mm and is preferably in the range from (L+10 mm) to (L+20 mm), more preferably in the range from (L+10 mm) to (L+15 mm).
24. Apparatus according to any of embodiments 1 to 23, where the roller R₃ is disposed in such a way that in the guiding of the strip P, the first contact point between the strip P and the roller R₃ is in the plane of an end face of the reel S or is disposed at a distance from this plane in a direction away from the reel.
25. Apparatus according to any of embodiments 1 to 24, where the rotational axis A₁ of the roller R₁ is positioned movably in space in such a way that the roller R₁ contacts, preferably contacts linearly, the reel S during the unwinding of the strip P.
26. Apparatus according to embodiment 25, where the rotational axis A₁ of the roller R₁ performs a movement in a radial direction with respect to the reel axis A_{S} during the unwinding of the strip P.
27. Apparatus according to any of embodiments 1 to 26, where the rollers R₂ and R₃ are guide rollers having spatially fixed rotational axes and where the reel axis A_{S} is a spatially fixed rotational axis.
28. Apparatus according to any of embodiments 1 to 27, where the rotational axes A₁ and A₂ are disposed in such a way that a free length of the strip P between the roller R₁ and the roller R₂ is in the range from 150 to 500 mm, preferably in the range from 200 to 300 mm.
29. Apparatus according to any of embodiments 1 to 28, where the rotational axes A₂ and A₃ are disposed in such a way that a free length of the strip P between the roller R₂ and the roller R₃ is in the range from 150 to 300 mm, preferably in the range from 200 to 250 mm.
30. Apparatus according to any of embodiments 1 to 29, where the roller R₃ is the last roller for guiding the strip P before the strip P is applied to the carrier material T.
31. Apparatus according to any of embodiments 1 to 29, according to (11) additionally comprising a rotatably mounted roller R₄ for guiding the strip P unwound at least partly from the reel, the roller R₄ being downstream of the roller R₃, where
   (II.4) the roller R₄ has a rotational axis A₄, where the angle α₄ between the rotational axis A₄ and the rotational axis A₃ is 90°, with a tolerance of ±1°.
32. Apparatus according to embodiment 31, where the roller R₄ has a guide flange on at least one side, preferably on both sides.
33. Apparatus according to embodiment 32, where the guide flanges disposed on both sides have a distance from one another in the range from (b+0.1 mm) to (b+0.9 mm), preferably in the range from (b+0.2 mm) to (b+0.8 mm), more preferably in the range from (b+0.3 mm) to (b+0.7 mm).
34. Apparatus according to embodiment 32 or 33, where the roller R₄ is the last roller for guiding the strip P before the strip P is applied to the carrier material T.
35. Apparatus according to embodiment 31 to 33, additionally comprising a rotatably mounted roller R₅ for guiding the strip P unwound at least partly from the reel, the roller R₅ being downstream of the roller R₄, where
   (II.5) the roller R_{S} has a rotational axis A_{S}, where the angle α₅ between the rotational axis A₅ and the rotational axis A₄ is 90°, with a tolerance of ±1°.
36. Apparatus according to embodiment 35, where the roller R₅ has a guide flange on at least one side, preferably on both sides.
37. Apparatus according to embodiment 36, where the guide flanges disposed on both sides have a distance from one another in the range from (b+0.1 mm) to (b+0.9 mm), preferably in the range from (b+0.2 mm) to (b+0.8 mm), more preferably in the range from (b+0.3 mm) to (b+0.7 mm).
38. Apparatus according to embodiment 35 to 37, where the roller R₅ is the last roller for guiding the strip P before the strip P is applied to the carrier material T.
39. Apparatus according to any of embodiments 1 to 38, where the application apparatus V is set up in such a way that it exerts at least one force on the strip P in a direction towards the carrier material T.
40. Apparatus according to embodiment 39, where the application apparatus V is set up in such a way that the force is exerted via at least one rubber roll.
41. Apparatus according to embodiment 39 or 40, where the application apparatus V is set up in such a way that the force is exerted via compressed air.
42. Apparatus according to any of embodiments 1 to 41, where the apparatus additionally comprises at least one bond application apparatus K for applying at least one bonding layer, preferably comprising at least one hotmelt adhesive.
43. Apparatus according to embodiment 42, where the bonding layer is applied to the carrier material T.
44. Apparatus according to any of embodiments 1 to 43, where the apparatus additionally comprises at least one separating unit for separating off lengths of the strip P, where the at least one separating unit is preferably downstream of the last roller, as defined in embodiment 30, 34 or 38.
45. Apparatus according to any of embodiments 1 to 44, where the apparatus additionally comprises at least one drive unit for driving the strip P and at least one brake unit for braking the strip P.
46. Apparatus according to embodiment 45, where the drive unit and the brake unit are set up to control a rotational movement of the reel S, where the rotational movement of the reel S preferably has an unwind velocity v of the strip P from the reel S of 0 m/min<v≤250 m/min, preferably of 100 m/min≤v≤200 m/min.
47. Apparatus according to embodiment 45 or 46, where the drive unit and the brake unit are downstream of the last roller, as defined in any of embodiment 30, 34 or 38.
48. Apparatus according to embodiment 45 or 46, where the drive unit is disposed in such a way as to drive the strip P by accelerating a rotational movement of the roller R₂ or of the roller R₃, where the brake unit is disposed in such a way as to brake the strip P by reducing a rotational movement of the reel S.
49. Method for applying a strip P comprising at least one microcreped paper to a carrier material T, where the method comprises the following steps:
   a) providing an apparatus according to any of embodiments 1 to 48;
   b) providing the at least one carrier material T;
   c) guiding the strip P from the reel S to the application apparatus V via the at least three rollers R₁, R₂ and R₃;
   d) applying the strip P on the carrier material T by means of the application apparatus V.
50. Method according to embodiment 49, where the carrier material T is at least one packaging blank.
51. Method according to embodiment 50, where the packaging blank consists of paper or board and is selected from the group consisting of a case, a carton, a folding box and a wrapper.
52. Method according to any of embodiments 49 to 51, where the applying in step d) comprises an exerting of at least one force on the strip P in a direction towards the carrier material T.
53. Method according to any of embodiments 49 to 52, where the method further comprises a step e) preceding step d), of
   e) providing a bond application apparatus K as defined in embodiment 42 and applying the bonding layer to the carrier material T by means of the bond application apparatus K.
54. Method according to embodiment 53, where the strip P is applied in step d) to the bonding layer applied to the carrier material, and so the bonding layer adjoins the carrier material T and the strip P.
55. Method according to any of embodiments 49 to 54, where the strip P is a tear strip.
56. Apparatus according to any of embodiments 1 to 48, where the strip P is a tear strip.
57. Use of an apparatus according to any of embodiments 1 to 48 for applying a strip P comprising at least one microcreped paper to a carrier material T.
58. A carrier material T comprising a strip P comprising at least one microcreped paper, where the carrier material T is obtained or obtainable by a method according to any of embodiments 49 to 55.

### BRIEF DESCRIPTION OF THE FIGURES

Further details and features of the present invention are evident from the description of exemplary embodiments. In these embodiments the respective features may be actualized alone or multiply in combination with one another. The invention is not confined to the exemplary embodiments. The exemplary embodiments are represented schematically in the figures. Identical reference numerals in the individual figures here denote identical or functionally identical elements or elements which correspond to one another in terms of their function.

Specifically:

FIGS. 1 to 3 show different exemplary embodiments of an apparatus for applying a strip P comprising a microcreped paper to a carrier material T, in side view (FIGS. 1 and 3) and also in perspective view (FIG. 2).

### DESCRIPTION OF THE EXEMPLARY EMBODIMENTS

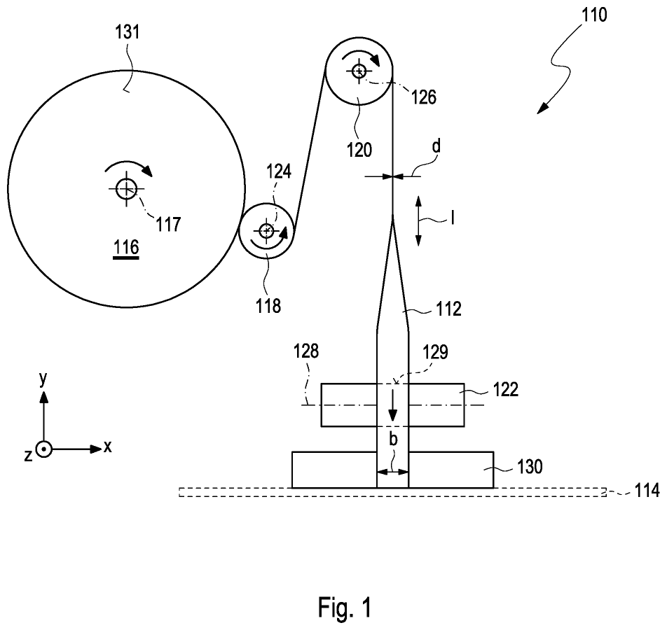

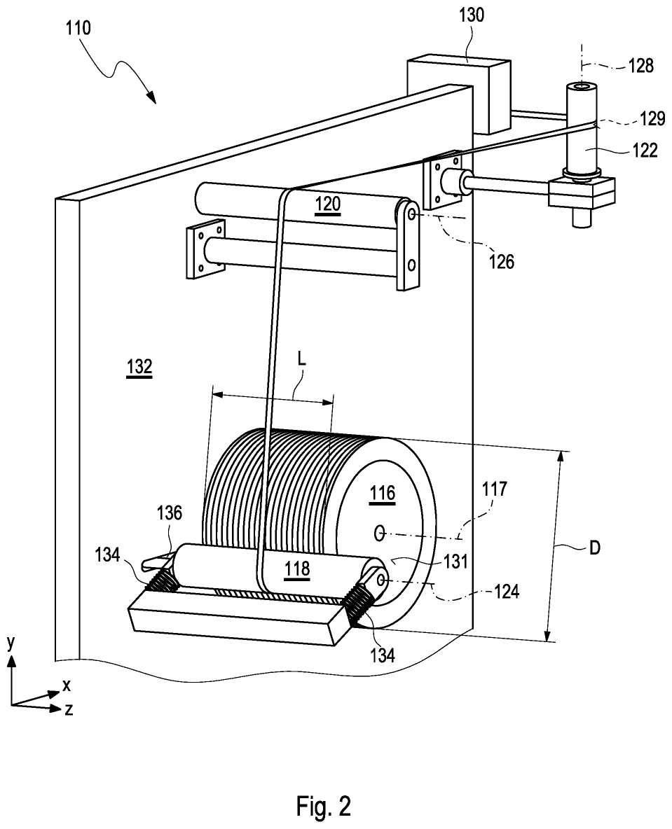

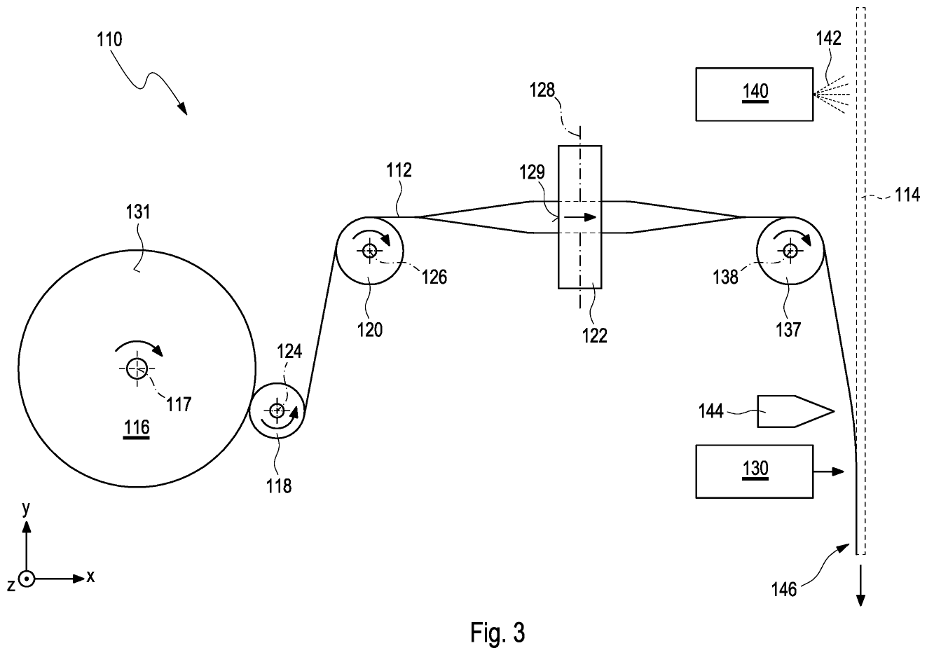

The figures are described in common. FIGS. 1 to 3 show different exemplary embodiments of an apparatus 110 for applying a strip P 112 comprising a microcreped paper to a carrier material T 114, in a side view (FIGS. 1 and 3) and also in perspective view (FIG. 2). The carrier material 114 is not part of the apparatus 110 and is therefore shown illustratively in FIGS. 1 and 3 by means of dashed lines. The strip 112 has an areal extent with a length l, a width b and a thickness d, where: l>>b>d.

The apparatus 110 comprises the strip 112 comprising the microcreped paper, which is wound to a reel S 116, the reel 116 being mounted rotatably about a reel axis A_{S} 117. The reel 116 preferably has a length L in the direction of the reel axis A_{S} 117 of not more than 310 mm and a diameter D of not more than 500 mm. The apparatus 110 further comprises three rotatably mounted rollers R₁ 118, R₂ 120 and R₃ 122 for guiding the strip 112 unwound at least partly from the reel 116, with a movement direction of the strip 112 being illustrated in the figures by arrows. The roller R₁ 118 is downstream of the reel 116, the roller R₂ 120 downstream of the roller R₁ 118, and the roller R₃ 122 downstream of the roller R₂. The roller R₁ 118 has a rotational axis A₁ 124, with the angle α₁ between the rotational axis A₁ and reel axis A_{S} being 0° with a tolerance of ±5°. The rotational axis A₁ 124 and the reel axis A_{S} 117 are preferably oriented in parallel to one another, for example along the z-axis of the Cartesian coordinate system represented illustratively in the figures. The roller R₂ 120 has a rotational axis A₂ 126, the angle α₂ between the rotational axis A₂ and reel axis A_{S} being 0° with a tolerance of ±10°. The rotational axis A₂ 126 and the reel axis A_{S} 117 are preferably oriented in parallel to one another, for example likewise along the z-axis of the Cartesian coordinate system represented. The roller R₃ 122 has a rotational axis A₃ 128, the angle α₃ between the rotational axis A₃ and rotational axis A₂ 126 of the roller R₂ being 90° with a tolerance of ±1°. The rotational axis A₃ 128 and the rotational axis A₂ 126 are preferably oriented orthogonally to one another, for example along the x-axis and the z-axis of the Cartesian coordinate system represented in FIG. 1, or along the x-axis and the z-axis as shown illustratively in FIGS. 2 and 3.

The roller R₃ 122 is preferably disposed in such a way that in the guiding of the strip 112, a first contact point 129 between the strip 112 and roller R₃ 122 is in the same plane as an end face 131 of the reel 116, for example in order to convert a back-and-forth movement of the strip 112 induced by the unwinding of the strip 112 from the reel 116, for example a zig-zag movement along the z-axis of the coordinate system shown in the figures, into a stable linear movement.

The apparatus 110 additionally comprises at least one application apparatus V 130 for applying the strip 112 to the carrier material 114. The application apparatus 130 is preferably set up to exert at least one force in a direction toward the carrier material 114 on the strip 112; this force is depicted illustratively in FIG. 3 by means of an arrow.

As shown illustratively in FIG. 2, the apparatus preferably further comprises at least one housing 132 for the spatial securement of the reel 116 and also of the rollers R₁ 118, R₂ 120 and R₃ 122. Here, the roller R₁ 118 is preferably secured in such a way that the roller R₁ 118 linearly contacts the reel 116 during the unwinding of the strip 112. For this purpose, further, the rotational axis A₁ 124 may preferably perform a spatial movement in a radial direction towards the reel axis 117. With further preference, as depicted illustratively in FIG. 2, a securing of the roller R₁ 118 in this way may be realized by means of two spring elements 134 and a groove 136 disposed in the housing 132. Other forms of securement as well, not shown here but familiar to the skilled person, are possible, examples being alternative mechanical and/or hydraulic and also electronic positional adaptations.

The apparatus 110 additionally preferably comprises at least one further cylindrical roller R₄ 137, the roller R₄ 137 being mounted rotatably about a rotational axis 138 and being positioned downstream of the roller R₃ 122. Preferably the rollers R₁ 118, R₂ 120, R₃ 122 and also the roller R₄ 137 of the apparatus 110 are passive, drive-free rollers, which are placed into rotation via a take-off of the strip 112. In FIG. 3, the take-off of the strip 112 is depicted illustratively by an arrow in negative y-direction at the right-hand margin of the figure, beneath the carrier material 114. The take-off may be generated, for example, by a movement of the carrier material 114.

The apparatus 110 additionally preferably comprises a bond application apparatus 140 for applying adhesive 142, preferably solvent-free adhesive, to the carrier material 114. The apparatus 110 additionally preferably comprises a separating unit 144 for separating off lengths of the strip 112. The apparatus 110 is used preferably for producing tear strips 146.

### LIST OF REFERENCE NUMERALS

110 Apparatus
112 Strip P
114 Carrier material T
116 Reel S
117 Reel axis A_{S}
118 Roller R₁
120 Roller R₂
122 Roller R₃
124 Rotational axis A₁
126 Rotational axis A₂
128 Rotational axis A₃
129 Contact point
130 Application apparatus V
131 End face
132 Housing
134 Spring element
136 Groove
137 Roller R₄
138 Rotational axis A₄
140 Bond application apparatus K
142 Adhesive
144 Separating unit
146 Tear strip

1. An apparatus for applying a strip P comprising at least one microcreped paper to a carrier material T, where the strip P has an areal extent with a length l, a width b and a thickness d where l>>b>d, where the apparatus comprises:
(I) the strip P comprising a microcreped paper and wound to a reel S, where the reel S is mounted rotatably about a reel axis A_{S};
(II) rotatably mounted rollers R₁, R₂ and R₃ for guiding the strip P at least partly unwound from the reel, where the roller R₁ is downstream of the reel S, the roller R₂ is downstream of the roller R₁, and the roller R₃ is downstream of the roller R₂; where
(II.1) the roller R₁ has a rotational axis A₁, where the angle α₁ between the rotational axis A₁ and the reel axis A_{S} is 0°, with a tolerance of ±5°;
(II.2) the roller R₂ has a rotational axis A₂, where the angle α₂ between the rotational axis A₂ and the reel axis A_{S} is 0°, with a tolerance of ±10°;
(II.3) the roller R₃ has a rotational axis A₃, where the angle α₃ between the rotational axis A₃ and the rotational axis A₂ is 90°, with a tolerance of ±1°;
(III) at least one application apparatus V, downstream of the roller R₃, for applying the strip P to the carrier material T;
where the at least one microcreped paper comprised in the strip P wound to the reel has the following properties:
(a) a tensile strength F_{Z} in at least one direction within the areal extent of the strip P, where F_{Z}≥8 kN/m, determined according to ISO 1924-3;
(b) an extensibility F_{D} in at least one direction within the areal extent of the strip P, where F_{D}≥4%, determined according to ISO 1924-3;
(c) a tearing resistance F_{R} in at least one direction within the areal extent of the strip P, where F_{R}≥1200 mN, determined according to ISO 1974.

2. The apparatus according to claim 1, where 8 kN/m≤F_{Z}≤22 kN/m, where 4%≤F_{D}≤16%, and where 1200 mN≤F_{R}≤4500 mN.

3. The apparatus according to claim 1, where the rollers R₁, R₂ and R₃ are cylindrical rollers.

4. The apparatus according to claim 1, where the roller R₃ is arranged in such a way that in the guiding of the strip P, the first contact point between the strip P and the roller R₃ lies in the plane of an end face of the reel S or is arranged at a distance from this plane in a direction away from the reel S.

5. The apparatus according to claim 1, where the rotational axis A₁ of the roller R₁ is positioned movably in space in such a way that during the unwinding of the strip P the roller R₁ contacts the reel S, where during the unwinding of the strip P the rotational axis A₁ of the roller R₁ performs a movement in a radial direction to the reel axis A_{S}.

6. The apparatus according to claim 1, where the rotational axes A₁ and A₂ are arranged in such a way that the free length of the strip P between the roller R₁ and the roller R₂ is in the range from 150 to 500 mm, and where the rotational axes A₂ and A₃ are arranged in such a way that the free length of the strip P between the roller R₂ and the roller R₃ is in the range from 150 to 300 mm.

7. The apparatus according to claim 1, in accordance with (II) additionally comprising a rotatably mounted roller R₄ for guiding the strip P at least partly unwound from the reel S, where the roller R₄ is downstream of the roller R₃, where
(II.4) the roller R₄ has a rotational axis A₄, where the angle α₄ between the rotational axis A₄ and the rotational axis A₃ is 90°, with a tolerance of ±1°.

8. The apparatus according to claim 1, where the apparatus additionally comprises at least one bond application apparatus K for applying at least one bonding layer.

9. A method for applying a strip P comprising at least one microcreped paper to a carrier material T, where the method comprises the following steps:
a) providing the apparatus according to claim 1;
b) providing the at least one carrier material T;
c) guiding the strip P from the reel S to the application apparatus V via the at least three rollers R₁, R₂ and R₃;
d) applying the strip P on the carrier material T by means of the application apparatus V.

10. The method according to claim 9, where the method further comprises a step e) preceding step d), of
e) providing a bond application apparatus K for applying at least one bonding layer and applying the bonding layer to the carrier material T by means of the bond application apparatus K.

11. The apparatus according to claim 2, where 10 kN/m≤F_{Z}≤21 kN/m, where 8%≤F_{D}≤15%, and where 1500 mN≤F_{R}≤4000 mN.

12. The apparatus according to claim 2, where 13 kN/m≤F_{Z}≤20 kN/m and where 2000 mN≤F_{R}≤3500 mN.

13. The apparatus according to claim 3, where at least one of the rollers R₁, R₂ and R₃ are substantially flange-free on at least one side.

14. The apparatus according to claim 3, where at least one of the rollers R₁, R₂ and R₃ are substantially flange-free on both sides.

15. The apparatus according to claim 3, where all the rollers R₁, R₂ and R₃ are substantially flange-free on at least one side.

16. The apparatus according to claim 3, where all the rollers R₁, R₂ and R₃ are substantially flange-free on both sides.

17. The apparatus according to claim 1, where the rotational axes A₁ and A₂ are arranged in such a way that the free length of the strip P between the roller R₁ and the roller R₂ is in the range from 200 to 300 mm, and where the rotational axes A₂ and A₃ are arranged in such a way that the free length of the strip P between the roller R₂ and the roller R₃ is in the range from 200 to 250 mm.

18. The apparatus according to claim 8, where the apparatus additionally comprises at least one separating unit for separating off lengths of the strip P.

19. The apparatus according to claim 8, where the apparatus additionally comprises at least one drive unit for driving the strip P and at least one braking unit for braking the strip P.
